(19) United States
(12) Patent Application Publication
(10) Pub. No.: US 2025/0301014 A1
(43) Pub. Date: Sep. 25, 2025

(54) SYSTEMS, METHODS, AND APPARATUS FOR CYBERATTACK MITIGATION AND PROTECTION FOR EXTREME FAST CHARGING INFRASTRUCTURE

(71) Applicant: Battelle Energy Alliance, LLC, Idaho Falls, ID (US)

(72) Inventors: Kenneth W. Rohde, Idaho Falls, ID (US); Richard W. Carlson, Rigby, ID (US); Sean C. Salinas, Idaho Falls, ID (US); Matthew J. Crepeau, Idaho Falls, ID (US)

(21) Appl. No.: 18/862,855

(22) PCT Filed: May 10, 2023
(86) PCT No.: PCT/US2023/066805

§ 371 Date: Nov. 4, 2024

Related U.S. Application Data
(60) Provisional application No. 63/364,469, filed on May 10, 2022.

(51) Int. Cl. H04L 9/40

(52) U.S. Cl. CPC H04L 63/1441; H04L 63/1425

(57) ABSTRACT

Systems for cyberattack mitigation and protection for an electric vehicle supply equipment (EVSE), including related methods and apparatus, is described. A system may include one or more controllers; analog measurement circuitry to measure analog signals associated with the EVSE; and one or more communications monitoring interfaces to monitor communications associated with operation of the EVSE. The one or more controllers is to determine one or more anomalous condition indicators at least partially responsive to at least one of the measured analog signals and the communications monitored via the one or more communications monitoring interfaces; and initiate or perform a mitigation action for the EVSE at least partially responsive to determining the one or more anomalous condition indicators.

### CROSS-REFERENCE TO RELATED APPLICATIONS

This application is a national phase entry under 35 U.S.C. § 371 of International Patent Application PCT/US2023/066805, filed May 10, 2023, designating the United States of America and published as International Patent Publication WO 2023/220615 A1 on Nov. 16, 2023, which claims the benefit under Article 8 of the Patent Cooperation Treaty of U.S. Patent Application Ser. No. 63/364,469, filed May 10, 2022.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates generally to systems for an electric vehicle supply equipment, and more specifically, to systems for cyberattack mitigation and protection for an electric vehicle supply equipment, as well as to related methods and apparatuses.

### BACKGROUND

The sale of electric vehicles (EVs) has been increasing in the United States in recent years. Along with the increasing number of EVs in use, public fast-charging infrastructure has also grown since its introduction in 2011. In addition to increasing the number of public fast-charging stations, the EV industry is also increasing charging power capacity. Auto manufacturers and charging-infrastructure providers are bringing to market vehicles and charging equipment capable of significantly higher power transfer to support shorter-duration charge times. As high-power charging systems come to market to meet consumer demand for faster and more convenient charging, the systems should also be safe and secure, especially considering the high voltage and high current levels at which they operate.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a block diagram of an example of a system for cyberattack mitigation and protection for an electric vehicle supply equipment (EVSE), according to one or more examples.

FIG. 2 is a block diagram of one or more communications monitoring interfaces that may be utilized in the system of FIG. 1.

FIG. 3 is an illustrative diagram of a more specific application of the system of FIG. 1 applied to an EVSE, according to one or more examples.

FIG. 4 is a flowchart for describing a method of operating a system for a charging station, according to one or more examples.

FIGS. 5A and 5B are flowcharts for describing a method of operating a system for a charging station, associated with the monitoring of communications in the method of FIG. 4, according to one or more examples.

FIG. 6 is a diagram of a system for cyberattack mitigation and protection for a plurality of EVSEs, according to one or more examples.

FIGS. 7, 8A-8C, and 9 are example display screens which may be generated at a human machine interface (HMI) utilizing the described system and methods, according to one or more examples.

FIG. 10 is a plot showing results of an extreme fast charging (XFC) power electronics communications manipulation exploit test, according to one or more examples.

FIGS. 11A and 11B are respective plots illustrating results of an XFC AC main contactor manipulation exploit, according to one or more examples.

FIGS. 12A and 12B are respective plots illustrating results of an XFC combined charging system (CCS) cable thermal management system performance test, according to one or more examples.

FIG. 13 is a plot illustrating results of an XFC internal communications “end charge session” exploit, according to one or more examples.

FIGS. 14A and 14B are respective plots illustrating results of a CCS cable cooling exploit, according to one or more examples.

FIGS. 15A and 15B are respective plots and illustrating results of an XFC hardware manipulation exploit, according to one or more examples.

FIG. 16 is a block diagram of a device that, in one or more examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Electric Vehicle (EV) usage in the US and around the world is growing steadily. With the increased prevalence of EVs, there is a demand for high-power (e.g., fast) charging infrastructure. Extreme fast charger (XFC) vendors (e.g., ABB, Tritium, ChargePoint, and others) are developing and deploying systems that include some safety features for protecting EV owners and the electric vehicles, but many of these safety features may be bypassed or manipulated via a cyberattack. The XFC industry lacks systems to actively monitor an XFC station to detect and prevent such malicious manipulation.

Disclosed in various embodiments herein is a system for the XFC infrastructure in support of the EV market. The system may be for cyberattack mitigation and protection for an XFC station. XFC stations, or high-power, Electric Vehicle Supply Equipment (EVSE), are grid-connected devices that draw significant amounts of energy. These XFC stations may be susceptible to cyber intrusion and attack, and as such may pose a threat to grid security and stability as well as the personal safety of EV owners. Various systems disclosed herein are operably coupled to, or even tightly integrated with, an XFC station to monitor for cyber intrusion and manipulation and notify the XFC operators to prevent injury or damage.

XFC stations are capable of causing serious harm to EV owners, and research has demonstrated that cyber manipulation of XFC stations may lead to unsafe conditions. A comprehensive system monitoring capability will further help vendors develop cyber resilient and safe XFC stations.

Cyber security may impact XFC infrastructure. High Consequence Event (HCE) scenarios may result in issues with grid stability, theft of personal information, and hazardous conditions for XFC station users, affecting safety. In one or more examples, the systems of the disclosure may be tightly integrated with the XFC station and directly monitor the XFC station for proper operations (e.g., logic), cyber intrusion, cyber manipulation, and grid stability issues. The system may flag events as warnings, alerts, or errors so that XFC operators (e.g., charge point operators (CPOs), such as Electrify America, Tesla, ChargePoint, and so on) may respond with proper mitigations. Accordingly, a more secure and resilient XFC infrastructure may be provided.

In one or more examples, the system may include a collection of hardware devices operably coupled to, or even tightly integrated with, an XFC station. This hardware monitors physical, logical and cyber properties of the XFC station to determine if it is operating within logical (e.g., deterministic) and expected limits.

In one or more examples, the physical properties may include a state of an XFC station (e.g., idle, charging, and so on), temperatures, input and output power levels, cabinet door states (e.g., open or closed), and so on.

In one or more examples, the logical properties of the XFC station may include determinations of whether measured physical properties match an expected state. By way of non-limiting example, if power is being transferred on a cable, a temperature of the cable should increase. Additionally, the logical properties may include a determination that state changes are occurring in a proper order. For example, it may be determined that an idle state transitions to a precharge state, and then to a cable-check state, and then to a charging state.

In one or more examples, the cyber properties of the XFC station may include network and communications properties for any connected communications systems (e.g., internal control systems, external management communications, remote access communications, and so on). Monitoring hardware may be connected to a central processor responsible for processing the data and determining abnormal behavior of the XFC station. The system monitors analog and digital signals (e.g., with sensors) of the XFC station, monitors the internal XFC command and control network, monitors communications between the XFC station and connected EV, and monitors the power quality of the grid connection to the XFC station.

In one or more examples, the system may use a variety of different methods to monitor the physical properties and behavior of a collection of EVSEs, such as DC Fast Chargers (DCFCs) and XFCs, located at a single charging station (e.g., analogous to a gas station). The system monitors each EVSE to ensure it is operating within the specifications for which it was designed, and that it is following the logical (e.g., deterministic) behavior for which it is specified to safely operate.

Additionally, the system may monitor critical support systems in the EVSE that help to operate the system safely. One example is the monitoring of the liquid cooled cable system to ensure the cable is properly cooled, in order to prevent physical damage and potential harm to users. The cooling system and temperature measurements of the system may be controlled via cyber tools. The system may utilize additional “side-channel” monitoring systems to ensure critical systems continue to function properly when they are either not properly monitored by the EVSE or actively tampered with via cyber approaches.

In one or more examples, portions of the system may be operated similarly to a conventional Safety Instrumented System (SIS) deployed in a critical Industrial Control System (ICS) process (e.g., petroleum refinery, nuclear power generation facility). The SIS is a redundant control and monitoring system that is not reachable by outside networks and, therefore, is isolated from conventional cyberattacks. A SIS may not typically interact directly with the monitored system, but may provide safety information for other controlling systems or human operators.

In one or more examples, the system framework may deploy a core monitoring node at each EVSE. The core monitoring nodes communicate safety and status information to one central node, referred to as an aggregator, located at the charging station. This allows the EVSE that is physically located at one site to be centrally monitored.

In one or more examples, the system may monitor many physical characteristics (e.g., physical properties) of the XFC station. The monitoring is used to determine, from the physical properties, the current operating state of the XFC station. The XFC operating state is tracked to ensure components of the system are operating as expected, for a given state. By way of non-limiting example, if the state of the XFC station shows that power is being transferred to an EV, the cable cooling system should be operational and the temperatures should be maintained within predetermined limits. If the physical properties do not match the expected values for a given state, warnings, alerts, or errors are generated.

Additionally, the system may monitor communications. Monitoring communications may include monitoring communications with external management systems, internal control systems, and XFC station to vehicle communications. These XFC communications, and their properties (e.g., message contents, message frequency, and so on), are monitored and compared to the expected operational state. If the communications are not as expected, warnings, alerts, or errors are generated.

In one or more examples, the system is designed to keep the user (e.g., the driver of vehicle) and the equipment safe (e.g., the user safe from bodily injury, and the equipment safe from hardware damage). The system may be suited for monitoring proper and safe operation. The system may detect improper behavior of the hardware and keep the hardware in a safe state.

In one or more examples, the system is intended to keep the XFC operational during harsh operating conditions (e.g., cyber or physical manipulation, hardware/component failures, weather and other environmental conditions, and so on), and maintaining a resilient XFC infrastructure (e.g., the XFC station may not cease operating when improper behavior is detected).

In one or more examples, the system provides a robust intrusion and anomaly detection system using a number of redundant inputs, enabling a high confidence in the identification of operational anomalies or cyber manipulation. For example, during a manipulation of the XFC liquid-cooled cable thermal-management system, the system may determine anomalies associated with this thermal management system by measuring the ambient temperature, liquid-cooled cable temperature, coolant pump power, and a direct current (DC) current delivered to the vehicle via measurements and communicated values. Additionally, door-switch states may be used to determine whether previous unauthorized access occurred. During high current charging at nominal ambient conditions, the thermal-management system may be operating within an expected power range to regulate the cable and connector temperatures to within thermal safety criteria. Operational anomalies, including cyber manipulation, may be detected if these signals or measurements do not correlate to one another or if any piece of information is out of expected bounds (example: reduced or no coolant flow, excessively high cable or connector temperature, measured DC transfer does not match delivered current, and so on). Therefore, the system may respond appropriately to avoid a safety issue or hardware damage.

In one or more examples, although the system may detect anomalies as a result of cybersecurity manipulation, the system also detects and mitigates a wide range of other anomalies caused by hardware malfunction, vandalism, or even natural environmental events.

As high-power EV charging infrastructure deployment and use increases, improved cybersecurity may improve safe and reliable operation. Conventional cybersecurity efforts generally focus on keeping cyber adversaries out of system networks. Events may be quantitatively prioritized, using impact severity and cyber manipulation complexity scoring. Laboratory evaluation with high-power charging infrastructure may be conducted on selected HCEs to verify or adjust the scoring of the impact severity and cyber manipulation complexity, thereby enabling the re-ranking and re-prioritization of the HCEs. Several mitigation solutions are included in several standards and recommended practices; however, specific mitigation solutions may also be helpful for the unique aspects of high-power charging infrastructure, one of which is the integration of the system into high-power charging-infrastructure hardware.

Specific mitigating actions for XFC charging station failure and intrusion may be implemented. In one or more examples, mitigation strategies and solutions may include implementing a secure boot by utilizing chip manufacturer features, controlling network segmentation (e.g., isolate from internet connected devices), implementing secure code signing of patches and firmware updates, using secure network communications methods (e.g., SSH, SSL/TLS), intrusion detection and prevention on remote access server(s) (e.g., based on techniques associated with intrusion detection systems (IDS), intrusion prevention systems (IPS), intrusion detection prevention system (IDPS), and so on), and implementing a zero-trust network architecture.

In one or more examples, mitigating actions may include a controlled shutdown during a stop charge event, wire mesh shielding of a combined charging system (CCS) cable, monitoring XFC operation such as electrical performance, temperatures, communications properties, and so on, and manage and filter control communications to ensure proper operations and allowed values. As is apparent, several general and specific mitigation solutions are available to improve the safety and resiliency of high-power charging and reduce the potential for HCEs.

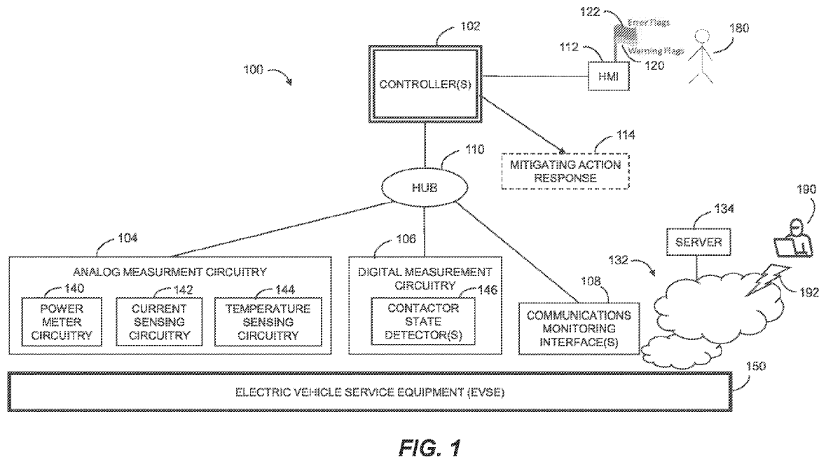

FIG. 1 is a block diagram of an example of a system 100 for cyberattack mitigation and protection for an EVSE 150, according to one or more examples.

In one or more examples, system 100 is configured to operate with EVSE 150, which provides XFC for charging electric vehicles. In one or more examples, the XFC station may be configured to handle about 350 kW or more of power transfer. In one or more examples, system 100 may be implemented and tightly integrated into EVSE 150; in other examples, system 100 may be interfaced with and/or loosely coupled with EVSE 150.

EVSE 150 may be controlled at least in part by communications received via one or more communication networks 132. In one or more examples, a server 134 of a Charging Network Operator (CNO) may be used to control charging at EVSE 150 via the one or more communication networks 132. One or more communication networks 132 may include an internal control network and one or more external networks. In one or more examples, the internal control network is a controller area network (CAN) or CAN network, in which control messages are used to control operation of EVSE 150. The one or more external networks may include a wide area network (WAN), such as the Internet, and/or a wireless WAN (WWAN), such as a cellular network. EVSE 150 may also be connected and/or part of a local area network (LAN) and/or a wireless LAN (WLAN).

A malicious actor 190 may operate in the one or more external networks to initiate one or more malicious communications 192 directed towards EVSE 150. The one or more malicious communications 192 may be or include a cyberattack, a cyber manipulation, a cyber tampering, and so on, in relation to EVSE 150.

For such cases, system 100 is operative to provide cyberattack mitigation and protection for EVSE 150. As shown in FIG. 1, system 100 may include one or more controllers (e.g., a controller 102, which may be a master controller), analog measurement circuitry 104, digital measurement circuitry 106, and one or more communications monitoring interfaces 108. In one or more examples, analog measurement circuitry 104, digital measurement circuitry 106, and one or more communications monitoring interfaces 108 may be connected to controller 102 via a hub 110. Hub 110 may be utilized to receive and transfer signals/information from the circuitry/interfaces to controller 102.

Analog measurement circuitry 104 is to measure analog signals associated with EVSE 150. Digital measurement circuitry 106 is to detect one or more states associated with EVSE 150. One or more communications monitoring interfaces 108 are used to monitor communications associated with operation of EVSE 150 (e.g., received in the internal control network or via the one or more external networks).

Controller 102 is to determine one or more anomalous condition indicators at least partially responsive to at least one of the measured analog signals, the one or more detected states, and the communications monitored. In one or more examples, the one or more anomalous condition indicators may be indicative of a cyberattack, a cyber manipulation, a cyber tampering, and so on, in relation to EVSE 150, for example, perpetrated by malicious actor 190 using malicious communications 192 via the one or more external networks. Controller 102 is to initiate or perform a mitigation action for EVSE 150 (e.g., a mitigating action response 114) at least partially responsive to determining the one or more anomalous condition indicators.

In one or more examples, controller 102 is to initiate or perform a mitigation action for EVSE 150, which may be or include sending, to a human machine interface (HMI) 112, an alert indication signal associated with the one or more anomalous condition indicators. In one or more examples, the alert indication signal may be seen or heard by an operator 180 (e.g., warning pop-ups, flashing indicators, highlighted text, sounds or beeps, sending of text messages or e-mails, and so on). In one or more examples, the alert indication signal may provide one or more warning flags 120 for warning operator 180, or one or more error flags 122 for alerting operator 180 of error in operation of EVSE 150.

In one or more examples of FIG. 1, analog measurement circuitry 104 may include power meter circuitry 140 (e.g., an alternating current (AC) power meter), current sensing circuitry 142, and temperature sensor circuitry 144. Power meter circuitry 140 may measure an AC input power level to the charging system of EVSE 150. Current sensing circuitry 142 may measure a DC output current level from the charging system of EVSE 150. Temperature sensor circuitry 144, which may include one or more temperature sensors, may measure measurement signals associated with EVSE 150. Analog measurement circuitry 104 may additionally measure a power level of a cable thermal management system of a CCS.

In one or more examples, digital measurement circuitry 106 may include one or more contactor state detectors 146. One or more contactor state detectors 146 may detect one or more digital states associated with EVSE 150, which may be or include one or more states of an AC input contactor to power electronics of EVSE 150, a DC contactor of a CCS cable, and/or a DC contactor of a CHAdeMO cable.

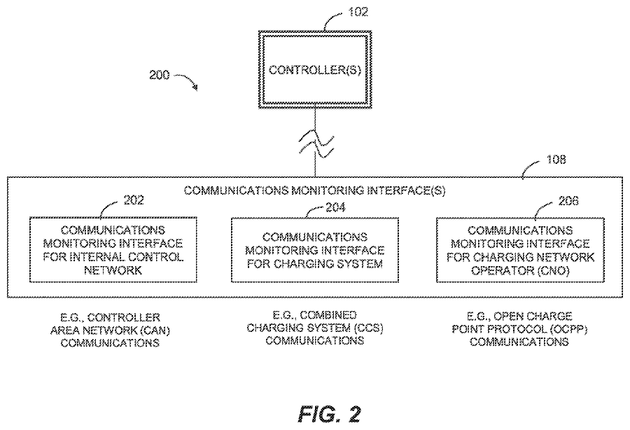

With reference now to system components 200 of FIG. 2, one or more communications monitoring interfaces 108 of FIG. 1 are shown to include a communications monitoring interface 202, a communications monitoring interface 204, and a communications monitoring interface 206.

In one or more examples of FIG. 2, controller 102 is operably coupled to communications monitoring interface 202 to monitor communications which are control messages communicated in the internal control network for the EVSE. For example, CAN communications (e.g., internal control messages) may be monitored using communications monitoring interface 202.

In one or more examples of FIG. 2, controller 102 is operably coupled to communications monitoring interface 204 to monitor communications between the EVSE and an electric vehicle. For example, CCS communications may be monitored using communications monitoring interface 204.

In one or more examples of FIG. 2, controller 102 is operably coupled to communications monitoring interface 206 to monitor communications between the EVSE and a remote smart energy management system. For example, OCPP communications may be monitored using communications monitoring interface 206.

With reference back to FIG. 1, as described above, controller 102 may initiate or perform a mitigation action for EVSE 150 responsive to determining one or more anomalous condition indicators, and the mitigation action may include the sending of an alert indication signal to HMI 112. In one or more examples, one or more additional mitigation actions of mitigating action response 114 may be initiated or performed responsive to one or more specific, determined anomalous conditions.

In one or more examples of mitigating action response 114, controller 102 may initiate or perform a mitigation action which includes setting a predetermined power level for electric vehicle charging to a reduced power level. In one or more examples, controller 102 may initiate or perform a mitigation action which includes controlling or modifying communications for a more controlled operation of EVSE 150. In one or more examples, controller 102 may initiate or perform OCPP curtailment. In one or more examples, controller 102 may initiate or perform a mitigation action which includes initiating a system reboot of EVSE 150.

In one or more examples of mitigating action response 114, controller 102 which is operably coupled to one or more communications monitoring interfaces 108 may determine one or more anomalous condition indications which includes detection of a control message having a message type that is disallowed in a current state of operation, and initiate or perform a mitigation action which includes blocking the control message from reaching a destination in EVSE 150 at least partially responsive to the detection.

In one or more examples of mitigating action response 114, controller 102 which is operably coupled to one or more communications monitoring interfaces 108 may determine one or more anomalous condition indications which includes detection of a control message having a control parameter that is out-of-range, relative to a predetermined valid range of control parameter values, and initiate or perform a mitigation action which includes blocking the control message from reaching a destination in EVSE 150, or limiting the value of the control parameter in the control message, at least partially responsive to the detection.

In one or more examples, one or more anomalous condition indicators (e.g., or severity levels of such anomalous conditions) may be determined based on predefined combinations of predetermined (anomalous) conditions or indicators associated with the measured analog signals, the one or more detected states, and the communications monitored. In one or more examples, the number and/or the extent of the mitigating actions of mitigating action response 114 for EVSE 150 may be (e.g., generally) proportional to the number and/or the extent of the one or more anomalous condition indicators (or severity levels of such anomalous conditions).

Thus, in one or more examples, several different signals may be monitored and compared, including communications traffic and messages, electrical measurements, temperature measurements, and component states. Communications traffic and messages may include, for example, XFC internal control message signals (e.g., CAN messages), CCS signals, and smart energy-management systems signals (e.g., OCPP signals, Open Platform Communications Unified Architecture, and so on). Electrical measurements may include, for example, AC power and power quality signals, DC output to EV signals, and auxiliary power signals which may include CCS liquid chiller power signals. Temperature measurements may include, for example, CCS cable system, power cabinet air temperature signals, and ambient air temperatures. Component states may include, for example, AC and DC contactors (e.g., AC input contactors, DC output contactors for each connector), and door switch signals.

Logic is implemented to identify anomalies, which may indicate intrusions and/or cyber exploit events. Functionality with the highest high consequence events (HCEs) exploits may be evaluated. Error and warning flags may be generated, and/or other mitigation actions may be initiated and/or performed, responsive to a determination that EVSE 150 is behaving improperly.

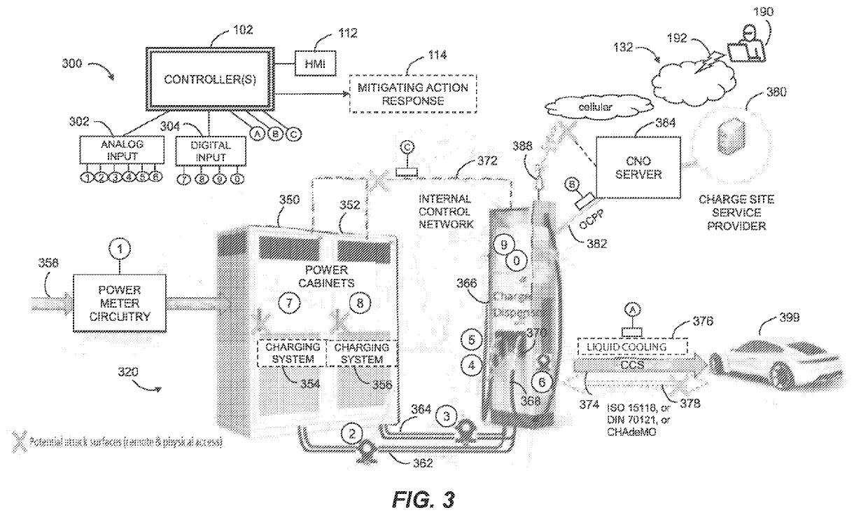

FIG. 3 is an illustrative diagram of a system 300 for cyberattack mitigation and protection for an EVSE 320, in a more specific application of the system of FIG. 1, according to one or more examples. System 300 is configured to operate with EVSE 320 which provides XFC for charging an electric vehicle 399. In one or more examples, electric vehicle 399 is a high-power charge-capable electric vehicle.

In FIG. 3, EVSE 320 is shown to include power cabinets 350 and 352 (e.g., primary and secondary cabinets) and a charging dispenser 366. Power cabinets 350 and 352 include charging systems 354 and 356, respectively (e.g., power electronics and the like). Charging systems 354 and 356 receive AC power via a connection 358, which receives the electric feed from the electric utility. Charging system 354 is connected to charging dispenser 366 via a cable 362, and charging system 356 is connected to charging dispenser 366 via a cable 364. For vehicle charging, charging dispenser 366 includes a cable 368 (e.g., a flexible bundle of conductors that connects EVSE 320 with electric vehicle 399) and a connector 370 (e.g., the end of cable 368 that interfaces with a vehicle inlet of vehicle 399), as well as another cable and connector combination for another vehicle. For example, charging to vehicle 399 may be provided via a cable 374 for CCS or a cable 378 for CHAdeMO.

EVSE 320 may include an internal control network 372, such as the CAN network, which may connect power cabinets 350 and 352 and charging dispenser 366 for operative control. For charging and related functions, EVSE 320 may be controlled at least in part by communications received via the one or more communication networks 132. In one or more examples, a CNO server 384 of a charge site service provider 380 may be used to control charging at EVSE 320 via the one or more communication networks 132 (e.g., Internet, cellular, Wi-Fi, and so on). If cellular or wireless signaling is utilized, EVSE 320 may communicate via an access point 388 or base station.

System 300 interfaces and/or is integrated with EVSE 320. System 300 includes controller 102 and HMI 112 as described in relation to FIGS. 1 and 2. In one or more examples, controller 102 may be or include a processor, such as a Raspberry Pi processor. Power meter circuitry (1) is connected to line 358 to measure an AC input power level. A DC current sensor (2) is connected to cable 362 to measure DC current level of cable 362, and a DC current sensor (3) is connected to cable 364 to measure DC current level of cable 364. Two temperature sensors (4) are provided at the two respective connectors at charging dispenser 366 to measure temperature, and two temperature sensors (5) are provided at the two respective cables at charging dispenser 366 to measure temperature. A current sensor (6) for a thermal management system 376 of a CCS cable 374 is also provided at charging dispenser 366. A main AC contactor state detector (7) is provided at power cabinet 350, and a main AC contactor state detector (8) is provided at power cabinet 352. A CCS contactor state detector (9) is provided at charging dispenser 366, and a CHAdeMO contactor state detector (10) is provided at charging dispenser 366.

In one or more examples of FIG. 3, controller 102 is operably coupled to one or more communications monitoring interfaces to monitor communications. In particular, a communications monitoring interface (A) (e.g., a CCS listener) is connected to receive communications between EVSE 320 and electric vehicle 399. For example, CCS communications may be monitored using communications monitoring interface (A). A communications monitoring interface (B) is connected to receive communications via a communication link 382, so that communications between EVSE 320 and a remote smart energy management system (e.g., from CNO server 384) may be monitored. For example, OCPP communications may be monitored using communications monitoring interface (B). A communications monitoring interface (C) is connected to the internal control network and is used to monitor communications comprising control messages communicated in the internal control network for EVSE 320. For example, CAN communications (e.g., internal control messages) may be monitored using communications monitoring interface (C).

As indicated in FIG. 3, all connections associated with (1), (2), (3), (4), (5), and (6) (all analog signals) may be input to an analog input 302 for controller 102 to process. All connections associated with (7), (8), (9), and (0) (all digital states) may be input to a digital input 304 for controller 102 to process. Connections for (A), (B), and (C) associated with communication monitoring interfaces may be input to controller 102.

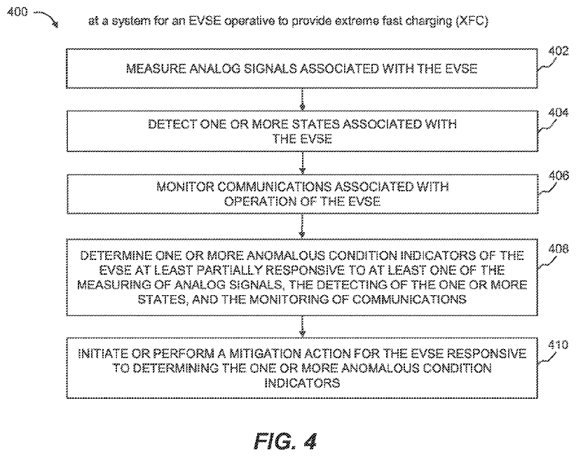

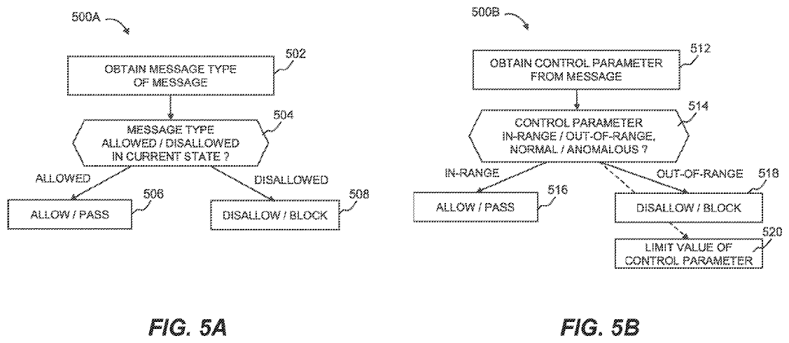

In one or more examples, system 300 may operate according to the same or similar operation as described in relation to FIGS. 1 and 2, as well as FIGS. 4, 5A, and 5B described below.

In system 300, analog signals are measured, digital states are determined, and communications are monitored. Analog signal measurements may include AC input signals, DC output current measurements, XFC temperature measurements, and CCS cable thermal management system power. AC input signals may include measurements of real power and power quality. Measurement of AC input to each power cabinet may be measured and monitored. By way of non-limiting example, an eGauge power meter may be used to measure power, power factor, and current Total Harmonic Distortion (iTHD). DC output current measurements may be performed by an analog current sensor on DC output from each power cabinet. DC output power may be calculated from analog current measurement and from monitored voltage measurement messages on the internal control network. XFC temperature measurements may include CCS liquid-cooled cable temperature measurements, CCS connector temperatures, and internal air temperatures of each power cabinet 350 and 352. CCS cable thermal management system power measurements may be performed by an analog current sensor on a DC input to thermal management system 376. Power may be calculated from an analog current sensor and assumed constant DC supply. In one or more examples, the DC input is a 24V DC input; however, thermal management system 376 may be powered by any suitable voltage chosen by the manufacturer (e.g., 12V, 24V. 120V, 240V, and so on).

Digital measurements may include determining whether the contactor state is open or closed. This determination may occur based on AC input contactor to the power electronics of each power cabinet 350 and 352, by a CCS cable DC contactor, or by a CHAdeMO cable DC contactor.

Communications monitoring may include XFC internal control message monitoring. Internal control system messages may use serial protocols, such as CAN or Profibus, or they may use Ethernet protocols, such as Modbus or Profinet. Furthermore, the SIS may monitor the main charge controller, CCS control board, CHAdeMO control board, power electronics controller, cable thermal management system controller, and so on. CCS listener tools, such as the CCS listener tool (e.g., by Vector), may monitor communication between the EV and XFC. By way of example, such monitoring may use the non-encrypted ISO 15118 or DIN 70121 protocols. In one or more examples, OCPP 1.6 communications may be monitored between the XFC and the OCPP server.

As indicated in FIG. 3, potential attack surfaces (“X”s) may be physical elements of the charging station and/or may be elements that are remotely accessed. By way of example, potential attack surfaces may include power cabinets 350 and 352 including the main AC contactors, internal control messages of CAN network 372, charge dispensing cables, a cellular connection at the charging station, and an OCPP server (e.g., CNO server 384) which coordinates communication between the charging station and charge site service provider 380.

In one or more examples, controller 102 may initiate or perform a mitigation action which includes setting a predetermined power level for electric vehicle charging to a reduced power level. In one or more examples, controller 102 may initiate or perform a mitigation action which includes controlling or modifying communications for a more controlled operation of EVSE 320. In one or more examples, controller 102 may initiate or perform OCPP curtailment. In one or more examples, controller 102 may initiate or perform a mitigation action which includes initiating a system reboot of EVSE 320.

In one or more specific examples, controller 102 may detect that the XFC chiller is not working or the cable temperature is too warm. In response, controller 102 may signal a digital output on the CCS listener to engage a relay that alters the signal on the temperature sensor (e.g., it may “spoof” one of the CCS cable temperature sensors). This causes the XFC station to detect the cable to be hotter than it actually is, which further causes the XFC station to activate one of its own current-limiting functions for preventing the cable from getting too hot. Although this method is different from the method of curtailment via OCPP, such mitigations may be considered together to attempt to allow the XFC station to continue charging at a high power (e.g., as high of a power as is possible) without the cable getting too hot, and before going to an extreme such as stopping the charge session, rebooting, and so on.

In one or more examples, system 300 may determine one or more anomalous condition indicators (e.g., or severity levels of such anomalous conditions) based on predefined combinations of predetermined (anomalous) conditions or indicators associated with the measured analog signals, the one or more detected states, and the communications monitored. In one or more examples, system 300 may initiate or perform one or more mitigation actions for EVSE 320 having a number and/or extent that is (e.g., generally) proportional to the number and/or the extent of the one or more anomalous condition indicators (e.g., or severity levels of such anomalous conditions).

FIG. 4 is a flowchart 400 for describing a method of operating a system for a charging station (e.g., which is or includes an EVSE), according to one or more examples. In one or more examples, the system is for cyberattack mitigation and protection for the charging system. In one or more examples, the EVSE is operative to provide XFC for charging EVs.

In FIG. 4, analog signals associated with the charging station are measured (step 402 of FIG. 4). One or more states associated with the charging station are detected (step 404 of FIG. 4). Communications associated with operation of the charging station are monitored (step 406 of FIG. 4). One or more anomalous condition indicators of the charging station are determined at least partially responsive to at least one of the measuring of analog signals, the detecting of the one or more states, and the monitoring of communications (step 408 of FIG. 4). A mitigation action for the charging station is initiated and/or performed responsive to determining the one or more anomalous condition indicators (step 410 of FIG. 4). The method of FIG. 4 may be repeated a number of times for continuous system operation.

In one or more examples of step 402, the measured analog signals associated with the charging station may be one or more of an AC input power level to a charging system of the charging station; a DC output current level from the charging system of the charging station; temperature measurement signals associated with the charging station; and a power level of a cable thermal management system of a CCS.

In one or more examples of step 404, the detected one or more states associated with the charging station may be one or more of an AC input contactor to power electronics of the charging station; a DC contactor of a CCS cable; and a DC contactor of a CHAdeMO cable.

In one or more examples of step 406, the monitored communications associated with operation of the charging station may be or include one or more of communications comprising control messages communicated in an internal control network for the charging station; communications between the charging station and an electric vehicle; and communications between the charging station and a remote smart energy management system.

In one or more examples of step 408, one or more anomalous condition indicators (e.g., or severity levels of such anomalous conditions) may be determined based on predefined combinations of predetermined (anomalous) conditions or indicators associated with the measured analog signals, the one or more detected states, and the communications monitored. In one or more examples of step 410, the number and/or the extent of the mitigating actions of mitigating action response 114 for EVSE 150 may be (e.g., generally) proportional to the number and/or the extent of the one or more anomalous condition indicators (or severity levels of such anomalous conditions).

In one or more examples of step 410, initiating or performing the mitigation action for the charging station may be one or more of: sending, to an HMI, an alert indication signal associated with the one or more anomalous condition indicators; setting a predetermined power level for electric vehicle charging to a reduced power level; and initiating a system reboot of the charging station.

In one or more examples of step 408, determining the one or more anomalous condition indications may be or include detection of a control message having a message type that is disallowed in a current state of operation, where in step 410, initiating or performing the mitigation action may be or include blocking the control message from reaching a destination in the charging station at least partially responsive to the detection.

In one or more examples of step 408, determining the one or more anomalous condition indications may be or include detection of a control message having a control parameter that is out-of-range relative to a predetermined valid range of control parameter values, wherein in step 410, initiating or performing the mitigation action may be or include blocking the control message from reaching a destination in the charging station, or limiting the value of the control parameter in the control message, at least partially responsive to the detection.

FIG. 5A is a flowchart 500A for describing a method of operating a system for an EVSE, according to one or more examples. The method of FIG. 5A may be associated with the monitoring of communications of step 406 of FIG. 4. The monitoring of communications may be or include control messages communicated in an internal control network for the charging station; communications between the charging station and an electric vehicle; and/or communications between the charging station and a remote smart energy management system.

In FIG. 5A, a message is examined. A message type of the message may be obtained (step 502 of FIG. 5A). It is determined whether the message type is allowed or disallowed in the current state of operation (step 504 of FIG. 5A). In one or more examples, each one of a plurality of states of operation may be associated with a whitelist of allowed message types and/or a blacklist of disallowed message types. Comparison of the current message type to the allowable/disallowable message types may be performed. The message is allowed or passed to reach its destination (e.g., in the charging station) responsive to determining that the message type is allowed in the current state (step 506 of FIG. 5A). The message is disallowed or blocked from reaching its destination (e.g., in the charging station) responsive to determining that the message type is disallowed in the current state (step 508 of FIG. 5A).

FIG. 5B is a flowchart 500B for describing a method of operating a system for an EVSE, according to one or more examples. As in FIG. 5A, the method of FIG. 5B may be associated with the monitoring of communications of step 406 of FIG. 4. Again, the monitoring of communications may be or include control messages communicated in an internal control network for the charging station; communications between the charging station and an electric vehicle; and/or communications between the charging station and a remote smart energy management system.

In FIG. 5B, a message is examined. A control parameter of the message may be obtained (step 512 of FIG. 5B). It is determined whether the control parameter is in-range or out-of-range, and/or normal or anomalous (step 514 of FIG. 5B). In one or more examples, the control parameter may be determined to be in-range or out-of-range relative to a predetermined valid/invalid range of control parameter values (e.g., based on a comparison of values). Here, a comparison of the current control parameter to the in-range/out-of-range control parameter values may be performed. The message is allowed to pass to reach its destination (e.g., in the charging station) responsive to determining that the control parameter is in-range and/or normal (step 516 of FIG. 5B). The message is disallowed or blocked from reaching its destination (e.g., in the charging station) responsive to determining that the control parameter is out-of-range and/or anomalous (step 518 of FIG. 5B). Alternately, the value of the control parameter is limited (e.g., set to an in-range value) and the message is allowed to pass to its destination (e.g., in the charging station) responsive to determining that the control parameter is out-of-range and/or anomalous (step 520 of FIG. 5B).

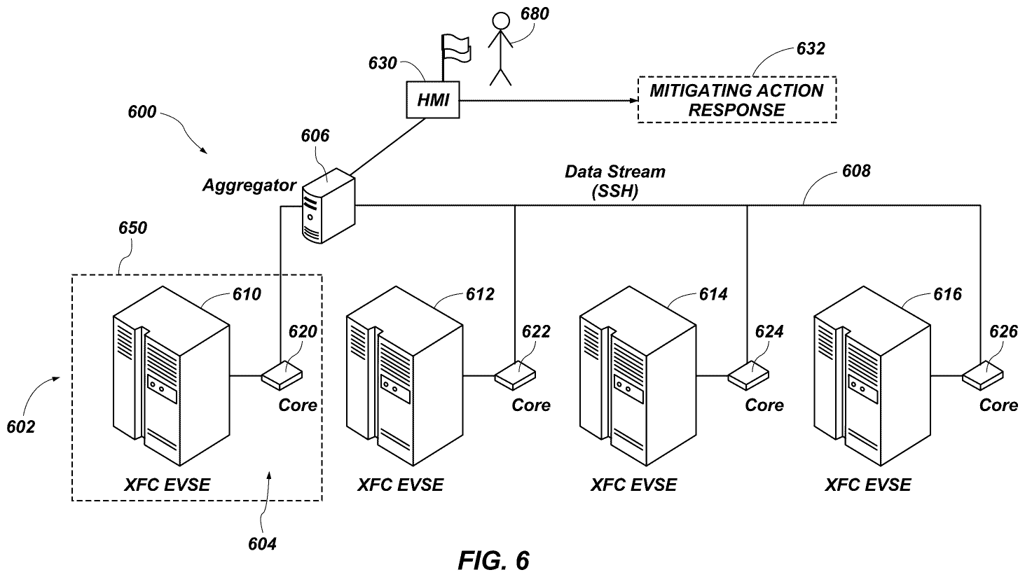

FIG. 6 is a diagram of a system 600 for cyberattack mitigation and protection for a plurality of EVSEs 602 (e.g., EVSEs 610, 612, 614, and 616) at a single charge site, according to one or more examples.

System 600 of FIG. 6 may include a plurality of core monitoring nodes 604 (e.g., core monitoring nodes 620, 622, 624, and 626), an aggregator node 606, and a data bus 608 (or connection). Each one of the core monitoring nodes 620, 622, 624, and 626 is associated with a respective one of EVSEs 610, 612, 614, and 616, and is operably coupled to the respective EVSE. Aggregator node 606 is operably coupled to each one of the core monitoring nodes 620, 622, 624, and 626 via data bus 608.

In one or more examples, each one of the core monitoring nodes 620, 622, 624, and 626 may be, or form part of, a system described in relation to FIGS. 1 and 2, and/or 3. For example, a subsystem 650 of FIG. 6 which includes core monitoring node 620 operably coupled to EVSE 610, may be, or form part of, system 100 as described in relation to FIG. 1 and/or system 300 as described in relation to FIG. 3. Each one of the core monitoring nodes 620, 622, 624, and 626 may referred to as a core system or “system.”

At each one of the core monitoring nodes 620, 622, 624, and 626, analog signals associated with the respective EVSE are measured, one or more states associated with the respective EVSE are detected, and communications associated with operation of the respective EVSE are monitored. In one or more examples, aggregator node 606 operates to collect data from the plurality of core monitoring nodes through data bus 608, via a data stream, for example, over a secure channel, such as Secure Shell (SSH) or Secure Sockets Layer (SSL)/Transport Layer Security (TLS).

Each one of the core monitoring nodes 620, 622, 624, and 626 operates to determine one or more anomalous condition indicators at least partially responsive to at least one of the measured analog signals, the detected one or more states, and the communications monitored. Each one of the core monitoring nodes 620, 622, 624, and 626, and/or aggregator node 606, operates to initiate or perform a mitigation action for the respective EVSE at least partially responsive to determining the one or more anomalous condition indicators.

In one or more examples, system 600 may include an HMI 630 operably coupled to aggregator node 606. In response to respective core monitoring nodes 620, 622, 624, and 626, aggregator node 606 operates to send to HMI 630 an alert indication signal associated with the one or more anomalous condition indicators. In one or more examples, the alert indication signal may be seen or heard by an operator 680 (e.g., warning pop-ups, flashing indicators, highlighted text, sounds or beeps, sending of text messages or e-mails, and so on). In one or more examples, the alert indication signal may provide one or more warning flags for warning operator 680, or one or more error flags for alerting operator 680 of error in operation of the EVSEs.

In one or more examples, the one or more anomalous condition indicators may be indicative of a cyberattack, a cyber manipulation, a cyber tampering, and so on, in relation to EVSEs 610, 612, 614, and 616, for example, perpetrated by a malicious actor using malicious communications via one or more external networks. Aggregator node 606 operates to initiate or perform a mitigation action for one or more of EVSEs 610, 612, 614, and 616 (e.g., a mitigating action response 632) at least partially responsive to determining the one or more anomalous condition indicators.

In one or more examples, at each one of the core monitoring nodes 620, 622, 624, and 626, analog signals may be measured. The analog signals may include one or more of an AC input power level to a charging system of the EVSE, a DC output current level from the charging system of the EVSE, temperature measurement signals associated with the EVSE, and a power level of a cable thermal management system of a CCS.

In one or more examples, at each one of the core monitoring nodes 620, 622, 624, and 626, one or more states associated with the respective EVSE may be detected. The one or more states associated with the respective EVSE may include one or more of an AC input contactor to power electronics of the EVSE, a DC contactor of a CCS cable, and a DC contactor of a CHAdeMO cable.

In one or more examples, at each one of the core monitoring nodes 620, 622, 624, and 626, the monitored communications may include one or more of communications comprising control messages communicated in an internal control network for the EVSE, communications between the EVSE and an electric vehicle, and communications between the EVSE and a remote smart energy management system.

In one or more examples, a core monitoring node may monitor control communications (e.g., CAN messages) to ensure only messages from an allowed list of messages occur during a given system state (e.g., different messages are present when charging a vehicle as compared to idle state). Disallowed messages are actively blocked. Laboratory testing has shown that arbitrary messages can be injected into a control system and cause the system to take unexpected actions. In this system, the EVSE may use the CAN bus for critical control messages, but other systems (i.e., other EVSE vendors) may use different protocols (e.g., Modbus). The system may be trained to monitor “known” messages while the EVSE is in different operating states (e.g., idle, pre-charge, charge, and so on). Messages that are not in the allowed list may be blocked. Conversely, messages that are identified in a disallowed list may be blocked.

In one or more examples, a core monitoring node may monitor control values to ensure only proper control parameters are used during a given system state (e.g., the coolant pump is not commanded to turn off during a charge operation). EVSE control parameters are passed in control messages. The core monitoring node monitors these control messages and alerts or blocks messages when values fall outside of expected valid ranges. Laboratory testing has shown that values for a state of charge (SOC) of the vehicle battery can be spoofed to negative values or values above 100%.

Thus, an aggregator node may collect data from the one or more core monitoring nodes and may issue Warnings, Alerts, and Errors (WAE) based on WAE prioritization scores. An aggregator node may also optionally notify a station operator or CNO of charge site issues.

As described previously, the system may initiate or perform a mitigation action which includes setting a predetermined power level for electric vehicle charging to a reduced power level. In one or more examples, a core monitoring node may request a reduction of power output (i.e., DC power output to a vehicle) when the cable temperature is rising and the coolant pump is not running. The coolant pump is normally always on/running when a vehicle is charging. This mitigation allows the EVSE to continue to charge the vehicle, albeit at a lower charge power, to prevent the cable from overheating. Laboratory testing has shown that the pump can be shut down remotely as the result of cyber tampering, or the pump may not start if it is damaged. The EVSE does not properly monitor if the pump is operational (i.e., it relies solely on cable temperatures).

Also as described previously, the system may initiate or perform a mitigation action which includes initiating a system reboot of the EVSE. In one or more examples, a core monitoring node will request an EVSE system reset (e.g., reboot) when conditions are beyond normal recovery mitigations. Laboratory testing has found conditions in which recovery of the EVSE requires a full system reboot. Normally, this option would be available only by having an electrician on-site to cut and restore power to the EVSE. However, in one or more examples, the core monitoring node may be equipped with remote relays that are able to interrupt the input power to the EVSE, causing a full system restart.

According to one or more examples, the system of the present disclosure operates with the following features and functionality in connection with the system operation described herein: (1) system failsafe; (2) automated actions; (3) abnormal condition detection; (4) independent system monitoring and control; (5) sensors, logic solvers and control elements; (6) network traffic and monitoring analysis; (7) open data format; (8) multiple system monitors; and (9) data aggregation. Conventional industrial control SIS may be associated with at least some or most of the features and functionality of (1) through (5), but not (6) through (9). On the other hand, conventional network Intrusion Detection Systems (IDS) may be associated with at least some or most of the features and functionality of (6) through (9), but not (1) through (5).

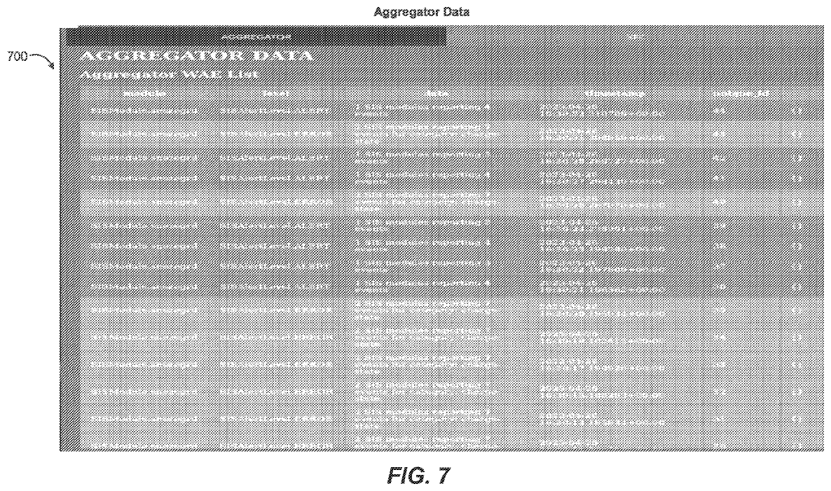

FIGS. 7, 8A-8C, and 9 are example display screens which may be generated at an HMI utilizing the system(s) and the method(s) previously described, according to one or more examples.

In general regarding the HMI, each of the core monitoring nodes are connected to the aggregator node (e.g., FIG. 6) and send EVSE status information and the Warning, Alert, and Error (WAE) events detected by a respective core monitoring node. The HMI display at the aggregator node may include an overview status page for the charge site, and further provide detailed pages for each of the monitored EVSE. A WAE list may be generated by the aggregator node, which is (1) a summary of the Alerts from each of the EVSE, and (2) new Alerts generated by the aggregator when WAE events are observed by more than one EVSE (e.g., multiple EVSE are being manipulated by a cyber actor). As an illustrative example, minor cyber activity may generate only Warning events at a single EVSE, but when these Warning events occur at all of the EVSEs, the aggregator node may generate an Alert event to notify the operator of wide-spread activity.

In particular, FIG. 7 is an example display screen 700 at an HMI, illustrating example aggregator data including an aggregator WAE list. The aggregator WAE list may be a summary of all of the core monitoring nodes. In one or more examples, the aggregator WAE list includes, for each one of multiple core monitoring nodes (or modules), data identifying the module, an indicated level (e.g., Warning, Alert, or Error), data indicating the number/type of events, a timestamp of the event, and a unique ID. Entries in the list may be highlighted for special alerts, and the highlighting may be color-coded (e.g., yellow=Warning, orange=Alert, and red=Error).

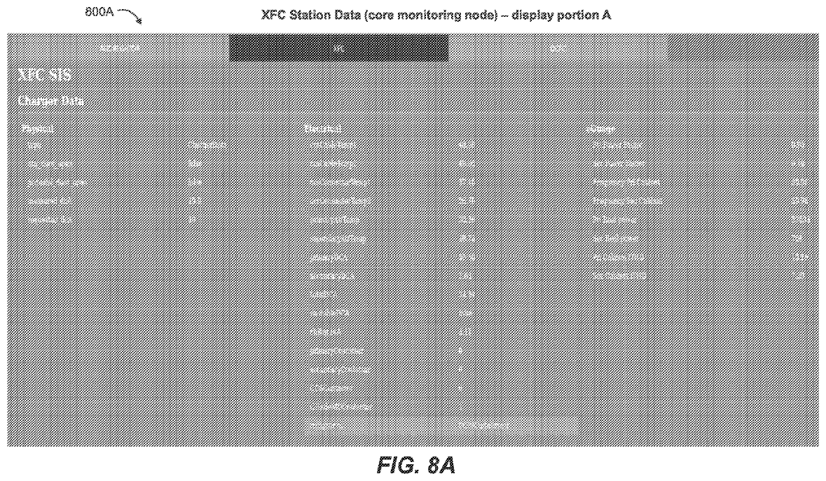

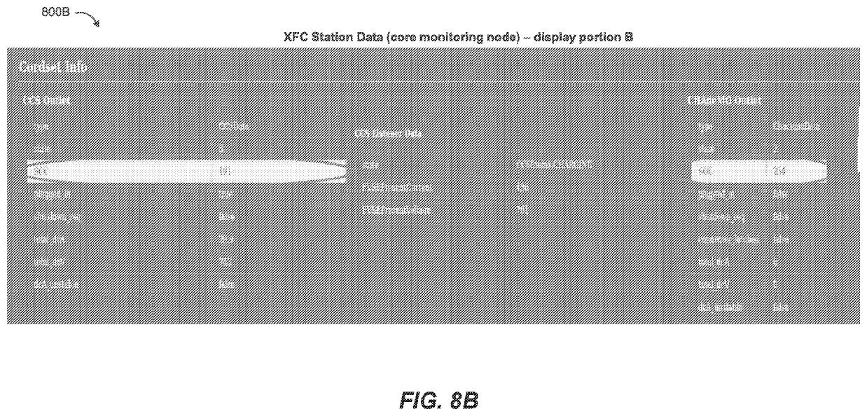

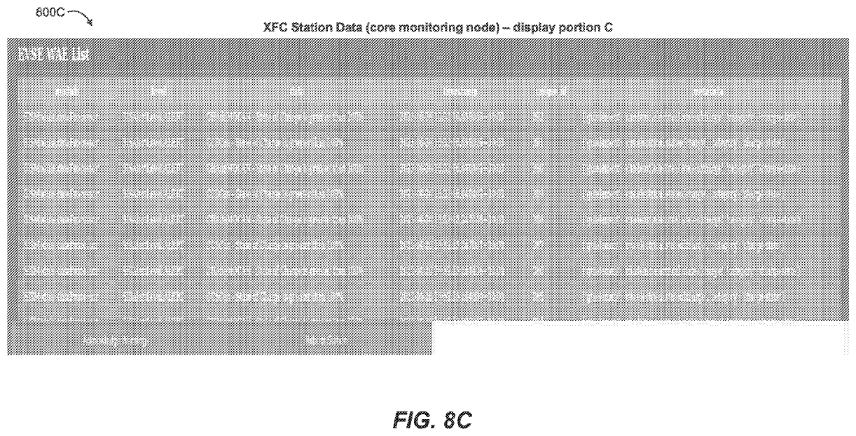

FIGS. 8A, 8B, and 8C form respective display portions 800A, 800B, and 800C of an example display screen at the HMI, illustrating example XFC data. In FIG. 8A, XFC charger data is shown. The XFC charger data includes physical data, electrical data, and gauge data (e.g., eGauge, a module comprised of an energy meter, data logger, and a web server). The physical data indicates a type (e.g., ChargerData), whether any door is open, whether a pedestal door is open, measured direct current amperage (dcA), and requested dcA. The electrical data includes cable temperature data, connector temperature data, air temperature data, dcA data, and contactor states. The gauge data indicates power factor data, frequency for each cabinet, real power data, and measured harmonic distortion in the current data.

In FIG. 8B, cordset information is shown, including CCS outlet data, CCS listener data, and CHAdeMO outlet data. The CCS outlet data indicates a type (e.g., CCS data), a state, a SOC, whether plugged in, whether shutdown is required, dcA data, dcV data, and whether dcA is unstable. The CCS listener data includes a state (e.g., charging), present current, and present voltage. The CHAdeMO outlet data includes the same types of data as the CCS outlet data. As indicated in FIG. 8B, the SOC for the CCS outlet is out-of-range (Alert), and the entry in the list is highlighted. Similarly, the SOC for the CHAdeMO outlet is out-of-range (Alert), and the entry in the list is also highlighted. Values that are in the wrong state may also be highlighted.

In FIG. 8C, an EVSE WAE list is shown. The EVSE WAE list includes, for each one of multiple core monitoring nodes (or modules), data identifying the module, an indicated level (e.g., Warning, Alert, or Error), data indicating the number/type of events, a timestamp of the event, and a unique ID. Metadata may also be provided. Mitigating action buttons or functions (e.g., for acknowledging or confirming one or more Warnings, and/or for rebooting the station, and so on) may also be provided.

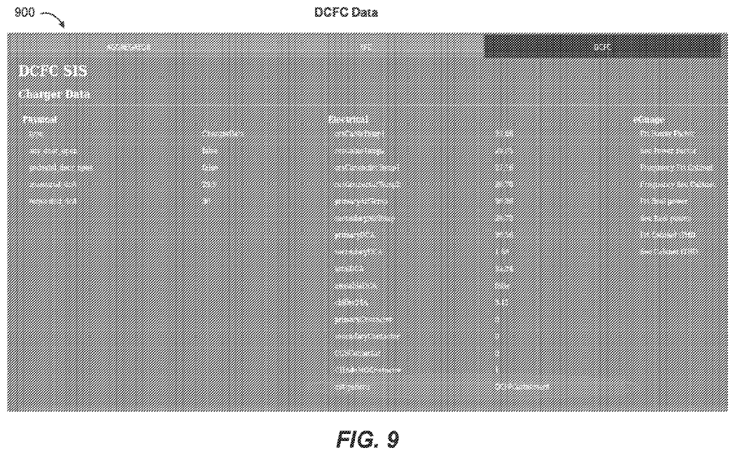

FIG. 9 is an example display screen 900 at an HMI for illustrating example DC Fast Charger (DCFC) data including charger data. The charger data in FIG. 9 includes the same type of data as described in relation to FIG. 8A. As indicated, an active mitigation for “OCPP curtailment” is in progress, and the entry in the list is highlighted.

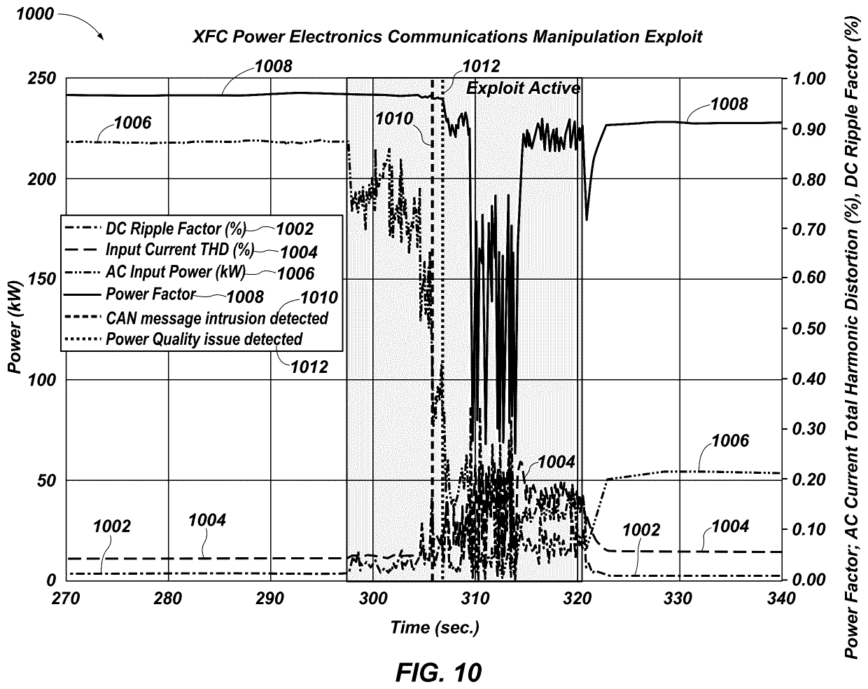

FIG. 10 is a plot 1000 showing results of an XFC power electronics communications manipulation exploit test, according to one or more examples. In FIG. 10, a dashed line 1010 indicates a time of detection of a CAN message intrusion and a dashed line 1012 indicates a time of detection of a power quality issue. Curves are shown for a DC ripple factor 1002, an input current total harmonic distortion (THD) 1004, an AC input power 1006, and a power factor 1008. In the example test, an internal controls communications exploit may disrupt power unit coordination, which may cause frequent “switch over” between power units, and may result in power transfer fluctuation. In FIG. 10, the system detected an intrusion and exploit for a CAN message within eight (8) seconds and detected power quality issues within ten (10) seconds.

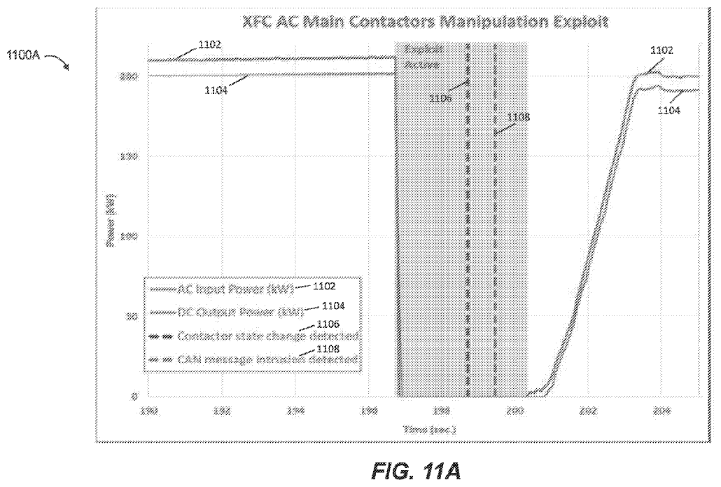

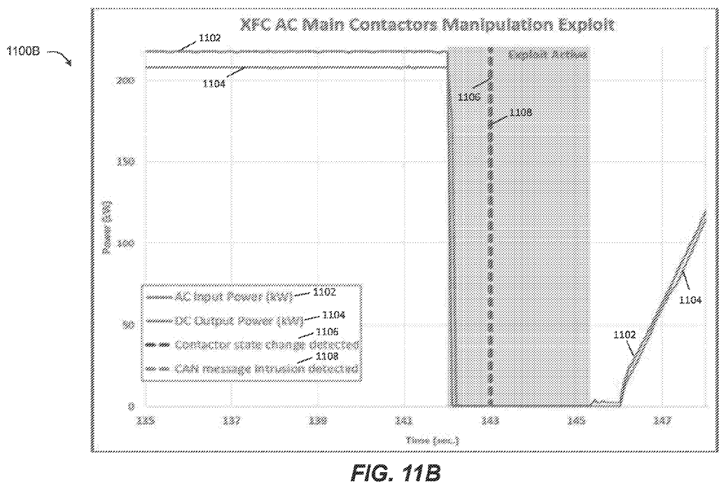

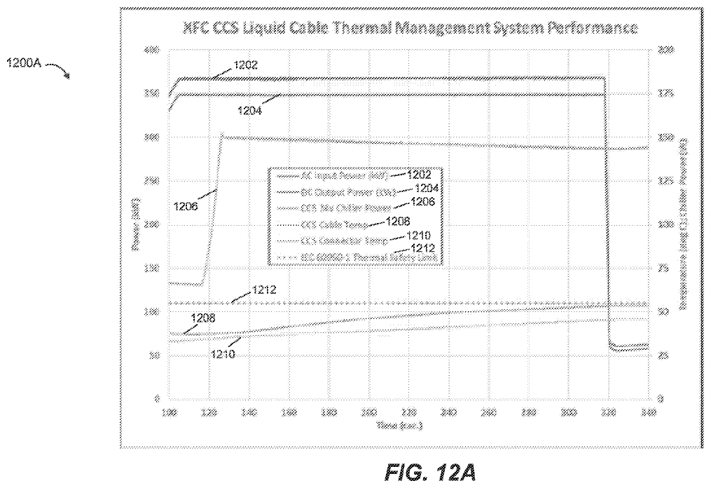

FIGS. 11A and 11B are respective plots 1100A and 1100B that illustrate results of an XFC AC main contactor manipulation exploit, according to one or more examples. In FIGS. 11A and 11B, a dashed line 1106 indicates a time of detection of a contactor state change and a dashed line 1108 indicates a time of detection of a CAN message intrusion. Curves are shown for an AC input power 1102 and a DC output power 1104. The results of the test shown may occur when main AC contactors are opened during high-power charging. As shown, the system detected an intrusion and exploit when the contactors were open between 1-2 seconds, and detected issues with the CAN message within between 1-3 seconds.

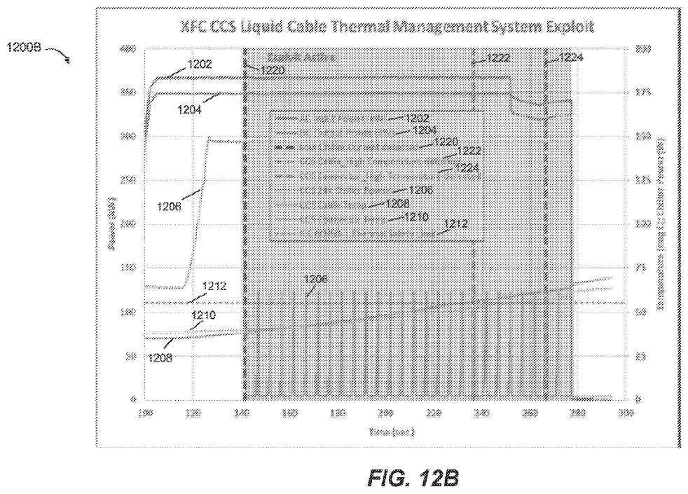

FIGS. 12A and 12B are respective plots 1200A and 1200B illustrating results of an XFC CCS cable thermal management system performance test, according to one or more examples. In FIGS. 12A and 12B, curves are shown for an AC input power 1202, a DC output power 1204, a CCS chiller power 1206, a CCS cable temperature 1208, a CCS connector temperature 1210, and a thermal safety limit 1212 (e.g., IEC 60950-1). In FIG. 12B, a dashed line 1220 indicates a time of detection of a low chiller current, and a dashed line 1222 indicates a time of detection of a CCS cable high temperature, a dashed line 1224 indicates a time of detection of a CCS connector high temperature. FIG. 12A illustrates the system performance under normal operating conditions. FIG. 12B illustrates the system performance during the exploit. In this exploit, the chiller was disabled and the CCS cable temperatures were spoofed during high-power charging. As shown in FIG. 12B, the system detected an intrusion and exploit for the low chiller current within one (1) second, and for the temperature limits within 1-9 seconds.

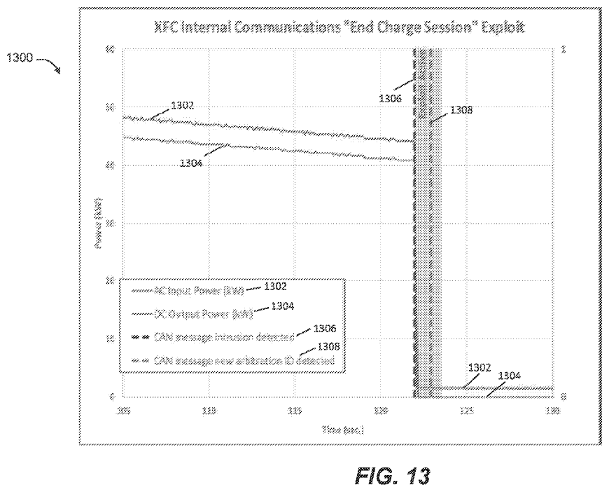

FIG. 13 is an example plot 1300 illustrating results of an XFC internal communications “end charge session” exploit, according to one or more examples. In FIG. 13, a dashed line 1306 indicates a time of detection of a CAN message intrusion and a dashed line 1308 indicates a time of detection of a CAN message new arbitration ID. Curves are shown for an AC input power 1302 and a DC output power 1304. In this exploit, XFC internal controls communications are given instructions to end a charge session, which may cause power transfer to stop, and may result in a denial of service and load shed. As shown in FIG. 13, the system detected an intrusion and exploit for the CAN message almost immediately (e.g., near to zero (0) seconds), and for the identified new message within one (1) second.

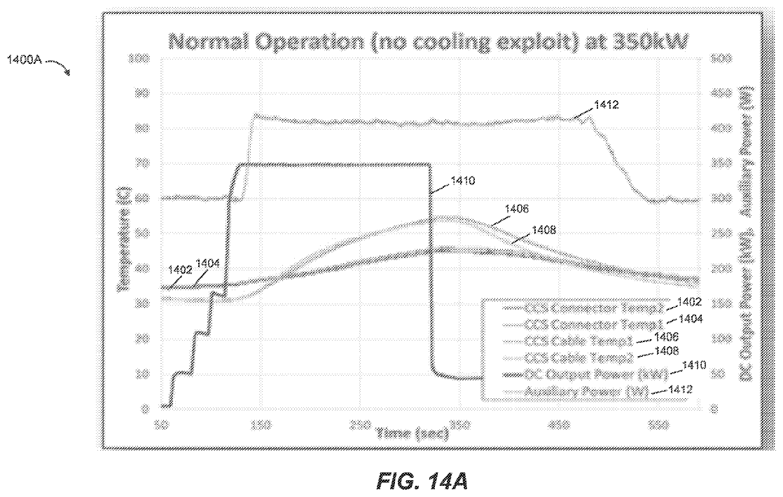

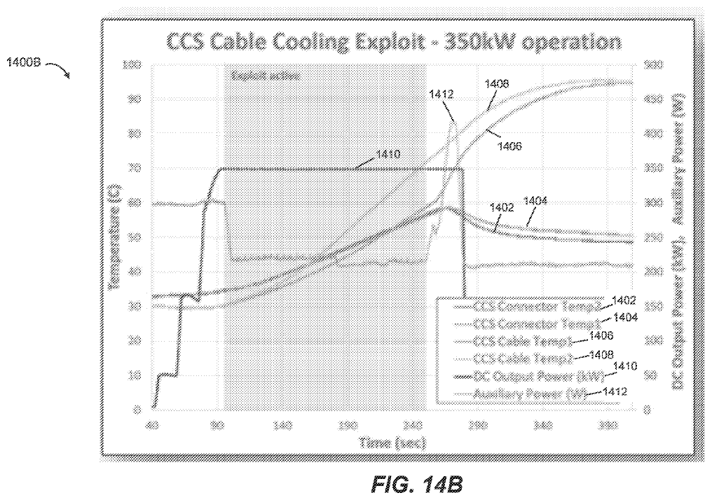

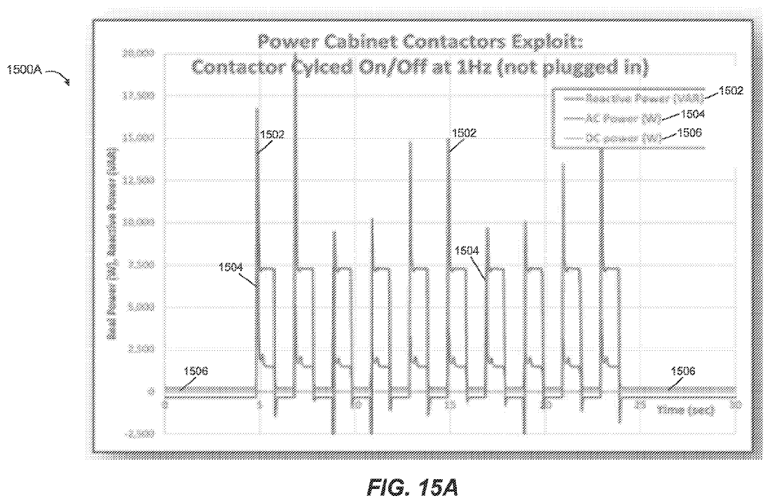

FIGS. 14A and 14B are respective plots 1400A and 1400B illustrating results of a CCS cable cooling exploit, according to one or more examples. In FIGS. 14A and 14B, curves are shown for a CCS connector temperature2 1402, a CCS connector temperature1 1404, a CCS cable temperature1 1406, a CCS connector temperature2 1408, a DC output power 1410, and an auxiliary power 1412. FIG. 14A shows normal operation of a cooled CCS cable with no cooling exploit at 350 kW. FIG. 14B shows results of a CCS cable cooling exploit at 350 kW. Vehicles with CCS inlet port temperature measurement may be more difficult to detect problems than others due, in part, to a high cyber complexity. Industry standards with vehicle inlet port temperature measurement may include, for example, ISO 17409 and IEC 61851-23 ed. 2. The lab exploit shown in FIG. 14B may include manipulation of XFC cable liquid chiller system, which may include temperature measurement, and coolant pump control. An exploit performed for vehicles without CCS inlet port temperature measurement is shown to be successful at 350 kW. Exploit of a cable liquid cooling system is possible when EV inlet port temperature is not monitored.

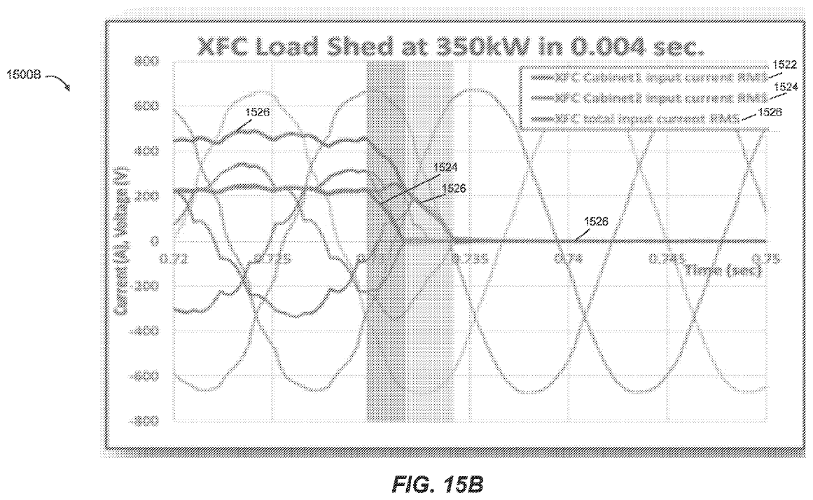

FIGS. 15A and 15B are respective plots 1500A and 1500B illustrating results of an XFC hardware manipulation exploit, according to one or more examples. In FIGS. 15A and 15B, curves are shown for a reactive power 1502 (in volt-amps reactive (VAR)), an AC power 1504, and a DC power 1506. FIG. 15A shows a power cabinet contactors exploit where the contactor is cycled on and off at 1 Hz and is not plugged in. FIG. 15B shows an XFC load shed at 350 kW in 0.004 seconds. A curve 1522 is associated with an XFC cabinet1 input current RMS, a curve 1524 is associated with an XFC cabinet2 input current RMS, and a curve 1526 is associated with an XFC total input current RMS. For power cabinet main AC contactor control, the contactor control was accomplished by turning on contactor while not plugged into an EV. Turning OFF while charging may open the contactors and end the charge event.

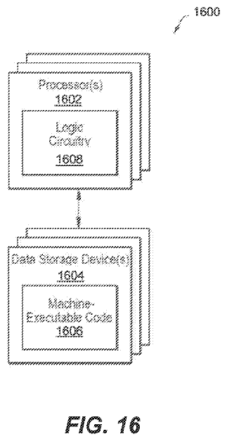

FIG. 16 is a block diagram of a device 1600 that, in one or more examples, may be used to implement various functions, operations, acts, processes, or methods disclosed herein. Device 1600 includes one or more processors 1602 (sometimes referred to herein as “processors 1602”) operably coupled to one or more apparatuses such as data storage devices (sometimes referred to herein as “storage 1604”), without limitation. Storage 1604 includes machine executable code 1606 stored thereon (e.g., stored on a computer-readable memory, without limitation) and processors 1602 include logic circuitry 1608. Machine executable code 1606 includes information describing functional elements that may be implemented by (e.g., performed by) logic circuitry 1608. Logic circuitry 1608 implements (e.g., performs) the functional elements described by machine executable code 1606. Device 1600, when executing the functional elements described by machine executable code 1606, should be considered as special purpose hardware may carry out the functional elements disclosed herein. In one or more examples, processors 1602 may perform the functional elements described by machine executable code 1606 sequentially, concurrently (e.g., on one or more different hardware platforms), or in one or more parallel process streams.

When implemented by logic circuitry 1608 of processors 1602, machine executable code 1606 may adapt processors 1602 to perform operations of examples disclosed herein. For example, machine executable code 1606 may adapt processors 1602 to perform at least a portion or a totality of the operations discussed in relation to controller 102 of FIGS. 1, 2, and 3 including any associated components; and more specifically, one or more operations described above, as generally provided in FIGS. 4, 5A, and 5B, without limitation.

Processors 1602 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes computing instructions (e.g., software code, without limitation) related to examples. It is noted that a general-purpose processor (may also be referred to herein as a host processor or simply a host) may be a microprocessor, but in the alternative, processors 1602 may include any conventional processor, controller, microcontroller, or state machine. Processors 1602 may also be implemented as a combination of computing devices, such as a combination of a DSP and a microprocessor, a plurality of microprocessors, one or more microprocessors in conjunction with a DSP core, or any other such configuration.

In one or more examples, storage 1604 includes volatile data storage (e.g., random-access memory (RAM), without limitation), non-volatile data storage (e.g., Flash memory, a hard disc drive, a solid state drive, erasable programmable read-only memory (EPROM), without limitation). In one or more examples processors 1602 and storage 1604 may be implemented into a single device (e.g., a semiconductor device product, a system on chip (SOC), without limitation). In one or more examples processors 1602 and storage 1604 may be implemented into separate devices.

In one or more examples, machine executable code 1606 may include computer-readable instructions (e.g., software code, firmware code, without limitation). By way of non-limiting example, the computer-readable instructions may be stored by storage 1604, accessed directly by processors 1602, and executed by processors 1602 using at least logic circuitry 1608. Also by way of non-limiting example, the computer-readable instructions may be stored on storage 1604, transmitted to a memory device (not shown) for execution, and executed by processors 1602 using at least logic circuitry 1608. Accordingly, in one or more examples logic circuitry 1608 includes electrically configurable logic circuitry.

In one or more examples, machine executable code 1606 may describe hardware (e.g., circuitry, without limitation) to be implemented in logic circuitry 1608 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, VERILOG®, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 1608 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in one or more examples machine executable code 1606 may include an HDL, an RTL, a GL description, a mask level description, other hardware description, or any combination thereof.

In examples where machine executable code 1606 includes a hardware description (at any level of abstraction), a system (not shown, but including storage 1604) may implement the hardware description described by machine executable code 1606. By way of non-limiting example, processors 1602 may include a programmable logic device (e.g., an FPGA or a PLC, without limitation) and the logic circuitry 1608 may be electrically controlled to implement circuitry corresponding to the hardware description into logic circuitry 1608. Also by way of non-limiting example, logic circuitry 1608 may include hard-wired logic manufactured by a manufacturing system (not shown, but including storage 1604) according to the hardware description of machine executable code 1606.

Regardless of whether machine executable code 1606 includes computer-readable instructions or a hardware description, logic circuitry 1608 performs the functional elements described by machine executable code 1606 when implementing the functional elements of machine executable code 1606. It is noted that although a hardware description may not directly describe functional elements, a hardware description indirectly describes functional elements that the hardware elements described by the hardware description are capable of performing.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used in the present disclosure, the terms “module” or “component” may refer to specific hardware implementations may perform the actions of the module or component or software objects or software routines that may be stored on or executed by general purpose hardware (e.g., computer-readable media, processing devices, without limitation) of the computing system. In one or more examples, the different components, modules, engines, and services described in the present disclosure may be implemented as objects or processes that execute on the computing system (e.g., as separate threads, without limitation). While some of the system and methods described in the present disclosure are generally described as being implemented in software (stored on or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, “each” means “some or a totality.” As used herein, “each and every” means “a totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” or “an” means “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, without limitation” or “one or more of A, B, and C, without limitation.” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

1. A system for cyberattack mitigation and protection for an electric vehicle supply equipment (EVSE), the system comprising:
one or more controllers;
analog measurement circuitry to measure analog signals associated with the EVSE; and
one or more communications monitoring interfaces to monitor communications associated with operation of the EVSE;
the one or more controllers to:
determine one or more anomalous condition indicators at least partially responsive to at least one of the measured analog signals and the communications monitored via the one or more communications monitoring interfaces; and
initiate or perform a mitigation action for the EVSE at least partially responsive to determining the one or more anomalous condition indicators.

2. The system of claim 1, comprising:
digital measurement circuitry to detect one or more states associated with the EVSE,
the one or more controllers to determine the one or more anomalous condition indicators at least partially responsive to at least one of the measured analog signals, the communications, and the one or more states.

3. The system of claim 2, wherein the digital measurement circuitry is to detect the one or more states associated with the EVSE comprising one or more of:
an alternating current (AC) input contactor to power electronics of the EVSE;
a direct current (DC) contactor of a combined charging system (CCS) cable; and
a DC contactor of a CHArge de MOve (CHAdeMO) cable.

4. The system of claim 1, wherein the analog measurement circuitry is to measure analog signals comprising one or more of:
an alternating current (AC) input power level to a charging system of the EVSE; and
a direct current (DC) output current level from the charging system of the EVSE.

5. The system of claim 1, wherein the analog measurement circuitry is to measure analog signals comprising temperature measurement signals associated with the EVSE.

6. The system of claim 1, wherein the analog measurement circuitry is to measure analog signals comprising a power level of a cable thermal management system of a combined charging system (CCS).

7. The system of claim 1, wherein the one or more controllers is operably coupled to the one or more communications monitoring interfaces to:
monitor communications comprising control messages communicated in an internal control network for the EVSE.

8. The system of claim 1, wherein the one or more controllers is operably coupled to the one or more communications monitoring interfaces to:
monitor communications between the EVSE and an electric vehicle.

9. The system of claim 1, wherein the one or more controllers is operably coupled to the one or more communications monitoring interfaces to:
monitor communications between the EVSE and a remote smart energy management system.

10. The system of claim 1, wherein the one or more controllers is to initiate or perform the mitigation action which comprises:
sending, to a human machine interface (HMI), an alert indication signal associated with the one or more anomalous condition indicators.

11. The system of claim 1, wherein the one or more controllers is to initiate or perform the mitigation action which comprises:
setting a predetermined power level for electric vehicle charging to a reduced power level.

12. The system of claim 1, wherein the one or more controllers is to initiate or perform the mitigation action which comprises:
initiating a system reboot of the EVSE.

13. The system of claim 1, wherein the one or more controllers is to:
determine the one or more anomalous condition indications which comprises detection of a control message having a message type that is disallowed in a current state of operation, and
initiate or perform the mitigation action which comprises blocking the control message from reaching a destination in the EVSE at least partially responsive to the detection.

14. The system of claim 1, wherein the one or more controllers is to:
determine the one or more anomalous condition indications which comprises detection of a control message having a control parameter that is out-of-range relative to a predetermined valid range of control parameter values, and
initiate or perform the mitigation action which comprises blocking the control message from reaching a destination in the EVSE, or limiting the value of the control parameter in the control message, at least partially responsive to the detection.

15. The system of claim 1, wherein the one or more controllers is to:
determine the one or more anomalous condition indicators indicative of a cyberattack, a cyber manipulation, or a cyber tampering with the EVSE via one or more external networks connected to the EVSE.

16. A method comprising:
at a system for an electric vehicle supply equipment (EVSE),
measuring analog signals associated with the EVSE;
monitoring communications associated with operation of the EVSE;
determining one or more anomalous condition indicators at least partially responsive to at least one of the measuring and the monitoring of communications; and
initiating or performing a mitigation action for the EVSE responsive to determining the one or more anomalous condition indicators.

17. The method of claim 16, wherein measuring the analog signals associated with the EVSE comprises one or more of:
measuring the analog signals comprising an alternating current (AC) input power level to a charging system of the EVSE;
measuring the analog signals comprising a direct current (DC) output current level from the charging system of the EVSE;
measuring the analog signals comprising temperature measurement signals associated with the EVSE; and
measuring the analog signals comprising a power level of a cable thermal management system of a combined charging system (CCS).

18. The method of claim 16, comprising:
at the system,
detecting one or more states associated with the EVSE,
wherein determining the one or more anomalous condition indicators of the EVSE is at least partially responsive to at least one of the measuring of analog signals, the monitoring of communications, and the detecting of the one or more states.

19. The method of claim 18, wherein detecting the one or more states associated with the EVSE comprises one or more of:
detecting the one or more states associated with an alternating current (AC) input contactor to power electronics of the EVSE;
detecting the one or more states associated with a direct current (DC) contactor of a combined charging system (CCS) cable; and
detecting the one or more states associated with a DC contactor of a CHArge de MOve (CHAdeMO) cable.

20. The method of claim 16, wherein monitoring communications associated with operation of the EVSE comprises one or more of:
communications comprising control messages communicated in an internal control network for the EVSE;
communications between the EVSE and an electric vehicle; and
communications between the EVSE and a remote smart energy management system.

21. The method of claim 16, wherein initiating or performing the mitigation action for the EVSE comprises one or more of:
sending, to a human machine interface (HMI), an alert indication signal associated with the one or more anomalous condition indicators;
setting a predetermined power level for electric vehicle charging to a reduced power level; and
initiating a system reboot of the EVSE.

22. The method of claim 16, wherein:
determining the one or more anomalous condition indications comprises detection of a control message having a message type that is disallowed in a current state of operation, and
initiating or performing the mitigation action comprises blocking the control message from reaching a destination in the EVSE at least partially responsive to the detection.

23. The method of claim 16, wherein:
determining the one or more anomalous condition indications comprises detection of a control message having a control parameter that is out-of-range relative to a predetermined valid range of control parameter values, and
initiating or performing the mitigation action comprises blocking the control message from reaching a destination in the EVSE, or limiting the value of the control parameter in the control message, at least partially responsive to the detection.

24. A system for cyberattack mitigation and protection for electric vehicle (EV) charging, the system comprising:
a plurality of core monitoring nodes, each one of the plurality of core monitoring nodes associated with a respective one of plurality of electric vehicle supply equipments (EVSEs);
each one of the plurality of core monitoring nodes to:
measure analog signals associated with a respective EVSE; and
monitor communications associated with operation of the respective EVSE; and
an aggregator node to collect data from the plurality of core monitoring nodes via a data bus.

25. The system of claim 24, each one of the plurality of core monitoring nodes and/or the aggregator node operative to:
determine one or more anomalous condition indicators at least partially responsive to at least one of the measured analog signals and the communications monitored; and
initiate or perform a mitigation action for the respective EVSE at least partially responsive to determining the one or more anomalous condition indicators.

26. The system of claim 25, comprising:
a human machine interface (HMI) operably coupled to the aggregator node,
wherein the aggregator node is to send to the HMI an alert indication signal associated with the one or more anomalous condition indicators.

27. The system of claim 24, each one of the plurality of core monitoring nodes operative to:
detect one or more states associated with the respective EVSE,
wherein the one or more states associated with the respective EVSE comprise one or more of:
an alternating current (AC) input contactor to power electronics of the EVSE,
a direct current (DC) contactor of a combined charging system (CCS) cable, and
a DC contactor of a CHArge de MOve (CHAdeMO) cable,
wherein the analog signals comprise one or more of:
an alternating current (AC) input power level to a charging system of the EVSE,
a direct current (DC) output current level from the charging system of the EVSE,
temperature measurement signals associated with the EVSE, and
a power level of a cable thermal management system of a combined charging system (CCS),
wherein the monitored communications comprise one or more of:
communications comprising control messages communicated in an internal control network for the EVSE;
communications between the EVSE and an electric vehicle; and
communications between the EVSE and a remote smart energy management system.
